(19) United States
(12) Patent Application Publication
(10) Pub. No.: US 2025/0222740 A1
(43) Pub. Date: Jul. 10, 2025

(54) BARREL AIRFLOW VOLUME CONTROL SYSTEM

(71) Applicant: GM GLOBAL TECHNOLOGY OPERATIONS LLC, Detroit, MI (US)

(72) Inventors: Angel Munoz Vazquez, Rochester Hills, MI (US); Steven Jay Leathorn, Fort Gratiot, MI (US); Louis Savich, White Lake, MI (US); Roman Szocinski, Clinton Township, MI (US)

(73) Assignee: GM GLOBAL TECHNOLOGY OPERATIONS LLC, Detroit, MI (US)

(21) Appl. No.: 18/404,222

(22) Filed: Jan. 4, 2024

(51) Int. Cl. B60H 1/00

(52) U.S. Cl. CPC B60H 1/00685; B60H 2001/00714

(57) ABSTRACT

Disclosed is a product that may include a barrel airflow volume control system, for a vehicle, including a first barrel door and a second barrel door operatively connected together so that the first barrel door and the second barrel door move away from each other to provide an air passageway opening therebetween, and move toward each other to reduce or close the air passageway opening between the first barrel door and the second barrel door.

### INTRODUCTION

The technical field generally relates to an airflow volume control system for a vehicle, components thereof, and methods of assembling.

### BACKGROUND

Vehicles have airflow control systems. However, many of such systems are bulky and require outlets/vents that occupy substantial dashboard space.

Accordingly, it is desirable to provide an airflow control system for a vehicle that has optimized packaging of components and provide airflow volume control with a relatively slim vent. Furthermore, other desirable features and characteristics of the variations disclosed herein will become apparent from the subsequent detailed description and the appended claims, taken in conjunction with the accompanying drawings and the foregoing.

### SUMMARY

A number of variations disclosed may include a product which may include a barrel airflow volume control system, for a vehicle, including a first barrel door and a second barrel door operatively connected together so that the first barrel door and the second barrel door may be moved away from each other to provide an air passageway opening therebetween, and may be moved toward each other to reduce or close the air passageway opening between the first barrel door and the second barrel door.

The product as set forth in claim 1, wherein the upper barrel door includes a first barrel portion having a first outer air blocking surface and a first arm and a second arm extending from opposite ends of the first barrel portion to define a first airflow opening between the first arm, second arm, and the first barrel portion, and wherein the lower barrel door includes a second barrel portion having a second outer air blocking surface, and a third arm, and fourth arm extending from opposite ends of the second barrel portion to define a second airflow opening between the third arm, fourth arm, and second barrel portion.

The product wherein a first outer air blocking surface is curved or has a convex shape.

The product wherein the upper barrel door includes a first barrel portion having a first inner air blocking surface and a first arm and a second arm extending from opposite ends of the first barrel portion to define a first airflow opening between the first arm, second arm, and the first barrel portion, and wherein the lower barrel door includes a second barrel portion having a second inner air blocking surface, and a third arm, and fourth arm extending from opposite ends of the second barrel portion to define a second airflow opening between the third arm, fourth arm, and second barrel portion.

The product further including a first sealing material over a portion of the first outer air blocking surface, and a second sealing material over a portion of the second outer air blocking surface.

The product wherein the first arm includes a first conic gear at one end of the first arm, and further comprising a second conic gear and operative connection with the first conic gear, wherein the second conic gear is held for rotational movement by a housing.

The product further including an integrated shaft having a third conic gear operatively connected to the second conic gear.

The product wherein the integrated shaft has a first end extending through a through hole formed in the first arm.

The product wherein the integrated shaft includes a second end having fourth conic gear near the second end of the integrated shaft.

The product further including a joystick having a rotary knob near a first end and a second end of the joystick including ⅕ conic gear position to engage the fourth conic gear.

The product further including a fork operatively connected to the joystick and a fork lever operatively connected to the fork.

The product 11 further including an airflow direction vane positioned between the upper barrel door and the second barrel door and connected to the fork lever to facilitate rotational movement of the airflow direction vane.

The product wherein the airflow direct vane may be moved to a position centered between the upper barrel door and lower barrel door, to a position partially or completely blocking the opening in the upper barrel door, to a position partially or completely blocking the opening in the lower barrel door.

The product wherein the integrated shaft has a cavity for receiving a portion of the fork lever and where a portion of the fork lever extends through a through hole in the integrated shaft.

The product wherein the fork lever includes a rod extending through a through hole in the integrated shaft, and a knob extending from the rod and received in a recess in the airflow direction vane to facilitate rotational movement of the airflow direction vane.

The product wherein the airflow direction vane includes a projection received in a through hole formed in the second end of the fourth arm.

The product wherein the integrated shaft includes a plurality of flats operatively engaging a plurality of flats formed in a first end of the third arm.

The product wherein the third arm has an end including a first ring portion constructed and arranged to be received in a through hole in the first arm.

A system including a barrel airflow volume control system, for a vehicle, comprising a first barrel door and a second barrel door operatively connected together so that the first barrel door and the second barrel door move away from each other to provide an air passageway opening therebetween, and move toward each other to reduce or close the air passageway opening between the first barrel door and the second barrel door; wherein the upper barrel door includes a first barrel portion having a first outer air blocking surface, and a first arm and a second arm extending from opposite ends of the first barrel portion to define a first airflow opening between the first arm, second arm, and the first barrel portion, and wherein the lower barrel door includes a second barrel portion having a second outer air blocking surface, and a third arm, and fourth arm extending from opposite ends of the second barrel portion to define a second airflow opening between the third arm, fourth arm, and second barrel portion; an airflow direction vane positioned between the upper barrel door and the lower barrel door and connected to the fork lever to facilitate rotational movement of the airflow direction vane from a first position centered with respect to the upper barrel door and the lower barrel door to the second position partially or completely closing an airflow opening in the upper barrel door to third position partially or completely closing an airflow opening in the lower barrel door.

A method including providing a barrel airflow volume control system, for a vehicle, comprising a first barrel door and a second barrel door operatively connected together so that the first barrel door and the second barrel door, wherein the upper barrel door includes a first barrel portion having a first outer air blocking surface and a first arm and a second arm extending from opposite ends of the first barrel portion to define a first airflow opening between the first arm, second arm, and the first barrel portion, and wherein the lower barrel door includes a second barrel portion having a second outer air blocking surface, and a third arm, and fourth arm extending from opposite ends of the second barrel portion to define a second airflow opening between the third arm, fourth arm, and second barrel portion, and an airflow direction vane positioned between the upper barrel door and the second barrel door and connected to the fork lever to facilitate rotational, moving the airflow direction vane from a first position centered with respect to the upper barrel door and the lower barrel door to the second position partially or completely closing an airflow opening in the upper barrel door to third position partially or completely closing an airflow opening in the lower barrel door; moving the upper barrel door and lower barrel door away from each other to provide an air passageway opening therebetween, and toward each other to reduce or close the air passageway opening between the first barrel door and the second barrel door.

### BRIEF DESCRIPTION OF THE DRAWINGS

The variations will hereinafter be described in conjunction with the following drawing figures, wherein like numerals denote like elements, and wherein:

FIG. 1 is a schematic plan view of a vehicle having a barrel airflow volume control system according to a number of variations;

FIG. 2 is a perspective, rear view of a barrel airflow volume control system according to a number of variations;

FIG. 3A is a perspective, partial rear view of a barrel airflow volume control system according to a number of variations;

FIG. 3B is a perspective, rear view, with portions sectioned and portions removed of FIG. 3A;

FIG. 3C is an enlarged view of a portion of FIG. 3B;

FIG. 4 is an exploded perspective view of a barrel airflow volume control system according to a number of variations;

FIG. 5 is a perspective, rear view of the upper barrel door with portions duplicated and enlarged according to a number of variations;

FIG. 6 is a perspective, rear view of the lower barrel door with portions duplicated and enlarged according to a number of variations;

FIG. 7 is a perspective, front view of the upper barrel door and lower barrel door with portions duplicated and enlarged according to a number of variations;

FIG. 8A is a perspective, partial, rear view of the upper barrel door and lower barrel door according to a number of variations;

FIG. 8B is a perspective, partial, rear view of the upper barrel door and lower barrel door according to a number of variations;

FIG. 9A is a perspective view of an integrated shaft according to a number of variations;

FIG. 9B is an enlarged portion of FIG. 9A with the addition of the second conic gear connected to the fourth conic gear on the integrated shaft according to a number of variations;

FIG. 9C is an enlarged portion of FIG. 9A showing one end of the integrated shaft according to a number of variations;

FIG. 9D is an enlarged portion of FIG. 9A with the addition of the second conic gear engaging the third conic gear and the first conic gear according to a number of variations;

FIG. 9E illustrates the engagement of the second conic gear with the third conic gear and the first conic gear herein gear teeth of the second conic gear are received in the pair of parallel grooves;

FIG. 10 is a perspective, front view of a barrel airflow volume control system illustrating a plurality of axes of rotation according to a number of variations;

FIG. 11 is a perspective, rear view of a barrel airflow volume control system illustrating a plurality of axes of rotation according to a number of variations;

FIG. 11 is a perspective, rear view of a portion of an airflow volume control system illustrating the upper door actuation using components and illustrating three axes of rotation.

FIG. 12 is a partial, enlarged view of a portion of FIG. 11;

FIG. 13 is a perspective, rear view of a portion of an airflow volume control system illustrating the lower door actuation using components and illustrating two axes of rotation;

FIG. 14 illustrate the axis A of rotation of the upper barrel door with respect to the axis B of rotation of the joystick;

FIG. 15A is a schematic illustration of a barrel airflow volume control system wherein the barrel doors and are in a fully open position and there is maximum airflow volume through the barrel airflow volume control system;

FIG. 15B is a schematic illustration of a barrel airflow volume control system wherein the barrel doors and are in a 75% open position and there is reduced airflow volume through the barrel airflow volume control system;

FIG. 15C is a schematic illustration of a barrel airflow volume control system wherein the barrel doors and are in a 25% open position and there is reduced airflow volume through the barrel airflow volume control system;

FIG. 15D is a schematic illustration of a barrel airflow volume control system wherein the barrel doors are in a fully closed position and there is no airflow volume through the barrel airflow volume control system;

FIG. 16 is a schematic illustration of a barrel airflow volume control system with the airflow direction vane completely blocking an opening in the upper barrel door and wherein the lower barrel door is completely open so that the air exiting the barrel airflow volume control system is in an upward direction towards a vehicle occupant's face;

FIG. 17 is a schematic illustration of a barrel airflow volume control system with the airflow direction vane completely blocking an opening in the lower barrel door and wherein the upper barrel door is completely open so that the air exiting the barrel airflow volume control system is in a downward direction towards a vehicle occupant's feet;

FIG. 18 is a schematic illustration of a barrel airflow volume control system with the airflow direction vane is partially blocking an opening in the upper barrel door with relatively small volume of air flowing through the upper barrel door and wherein the lower barrel door is completely open so that the air exiting the barrel airflow volume control system is in an upward direction towards a vehicle occupant's face;

FIG. 19 is a schematic illustration of a barrel airflow volume control system with the airflow direction vane is centered with respect to the upper barrel door and the lower barrel door, and the upper barrel door and the lower barrel door are both completely open so that the air exiting the barrel airflow volume control system is in a direction between a vehicle occupant's face and feet;

FIG. 20 is a schematic illustration of a barrel airflow volume control system with the airflow direction vane is centered with respect to the upper barrel door and the lower barrel door, and the upper barrel door and the lower barrel door are completely closed so that no air is flowing through the barrel airflow volume control system.

### DETAILED DESCRIPTION

The following detailed description is merely illustrative in nature and is not intended to limit the application and uses. Furthermore, there is no intention to be bound by any expressed or implied theory presented in the preceding technical field, background, brief summary or the following detailed description.

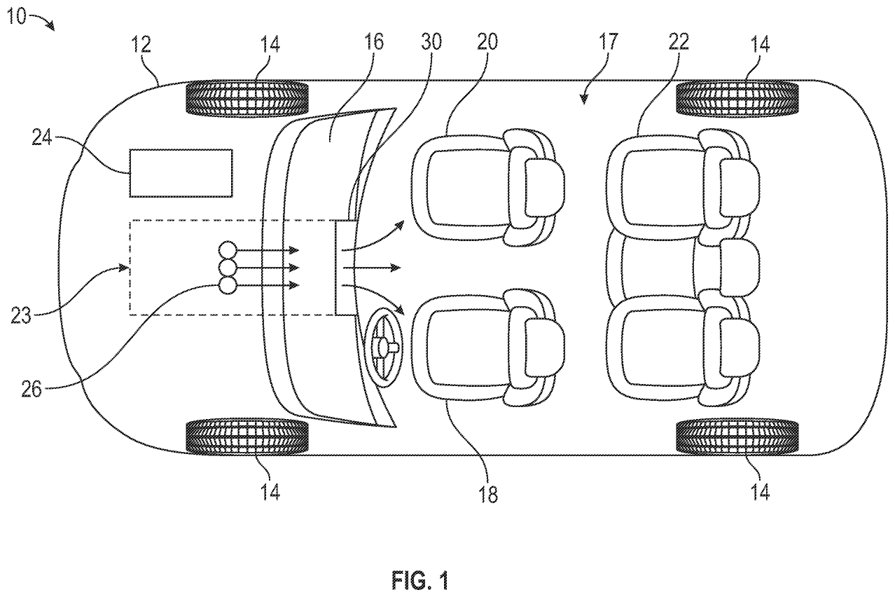

FIG. 1 is a schematic plan view of a vehicle 10 having a product including a barrel airflow volume control system 30 according to a number of variations. The vehicle 10 may include a body 12 carried by a frame (not shown), and may include a plurality of wheels 14 to propel and turn the vehicle. At least one vehicle component 24 may be used to heat, cool, and/or ventilate a vehicle passenger compartment 17. The vehicle may include a combustion engine using gasoline, propane, natural gas, biofuel or other combustible material, or a fuel cell engine, or a battery-powered engine. A passenger seat 18, front passenger seat 20, and at least one rear passenger seat 22 may be provided in the vehicle passenger compartment 17. A heating, ventilation, air conditioning system (HVAC) 23 may be provided in the vehicle and may include a fan 26 the flow of air through a barrel airflow volume control system 30.

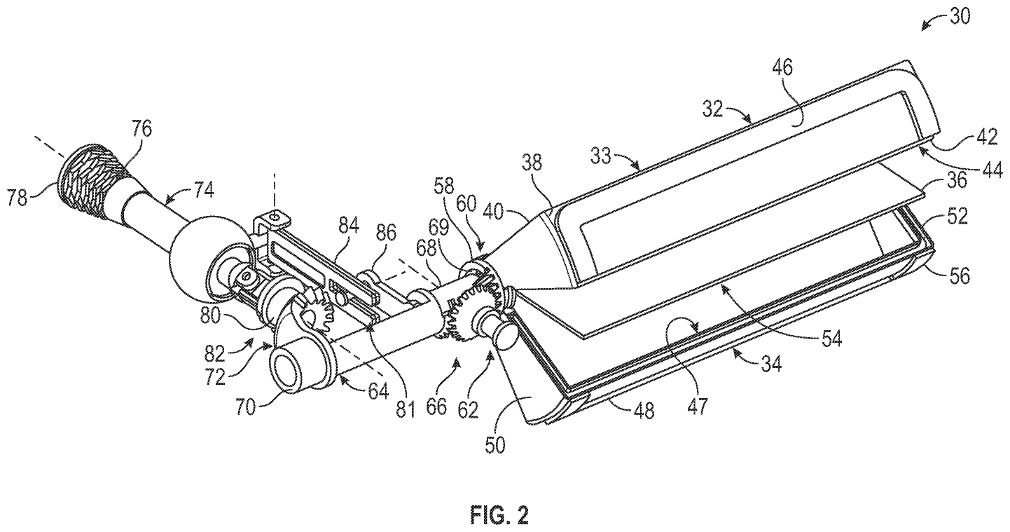

FIG. 2 is a partial, perspective, rear view of a barrel airflow volume control system 30 according to a number of variations. The barrel airflow volume control system 30 may include an upper barrel door 32 operatively connected to a lower barrel door 34, and an airflow direction vane 36. In a number of variations, the upper barrel door 32 may include a first barrel portion 33 having a first outer air blocking surface 38, which may be curved or have a convex shape. In a number of variations, a first arm 40 and a second arm 42 may extend from opposite ends of the first barrel portion 33 to define a first airflow opening 44 between the first arm 40, second arm 42, and the first barrel portion 33. In a number of variations, a first sealing material 46, such as but not limited to, a felt material may be provided over a portion of the first outer air blocking surface 38 of the upper barrel door 32. In a number of variations, the lower barrel door 34 may include a second barrel portion 47 which may have a second outer air blocking surface 48. A third arm 50, and fourth arm 52 may extend from opposite ends of the second barrel portion 47 to define a second airflow opening 54 between the third arm 50, fourth arm 52, and second barrel portion 47. A second sealing material 56, such as but not limited to, a felt material may be provided over a portion of the second outer air blocking surface 48.

In a number of variations, a product which may include a barrel airflow volume control system 30, for a vehicle, including a first or upper barrel door 32 and a second or lower barrel door 34 operatively connected together so that the first or upper barrel door 32 and the second or lower barrel door 34 move away from each other to provide an air passageway opening therebetween, and move toward each other to reduce or close the air passageway opening between the first or upper barrel door 32 and the second or lower barrel door 34.

The first arm 40 may include a first conic gear 60 at one end of the first arm 40. A second conic gear 62 may be connected to the first conic gear 60. The second conic gear 62 may be held for rotational movement by a housing as described hereafter. The second conic gear 62 may be operatively connected to third conic gear 66 formed on an integrated shaft 64. The integrated shaft 64 may have a first end 68 extending into a first through hole 69 formed in the first arm 40. The integrated shaft 64 may have a second end 70 and a fourth conic gear 72 near the second end 70. The barrel airflow volume control system 30 may include a joystick 74 having a rotary knob 76 near a first end 78 of the joystick 74. A second end 80 of the joystick 74 may include fifth conic gear 82 positioned to engage the fourth conic gear 72. A fork 84 may be operatively connected to the joystick 74 and a fork lever 86 operatively connected to the fork 84.

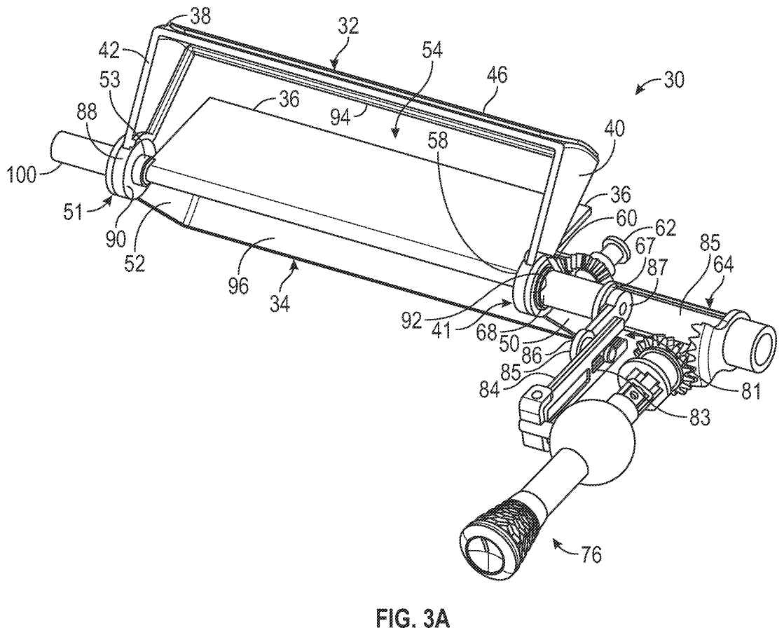

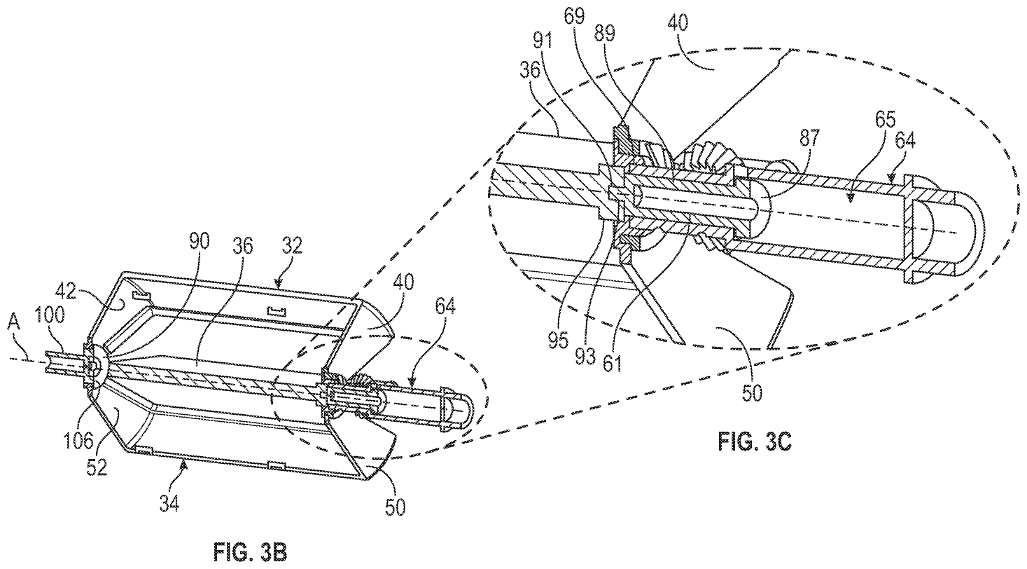

FIG. 3A is a partial, perspective, front view of a barrel airflow volume control system 30 according to a number of variations. The integrated shaft 64 may have a cavity 65 for receiving a portion of the fork lever 86 and a through hole 67 may be formed in the integrated shaft 64 to receive a projection 87 of the fork lever 86. The projection 87 is coupled to the airflow direction vane 36 to rotate the same. A second end 85 of the fork lever 86 may have a projection 83 received in a slot 81 of the fork 84. A second end 88 of the second arm 42 may have a through hole 90 formed therein to receive a projection extending from the airflow direction vane 36. The upper barrel door 32 may have a first inner air blocking face 94 that is opposite the first outer air blocking surface 38. The orientation of the barrel airflow volume control system 30 may be flipped around so that the upper barrel door 32 is closest to the air exit into the vehicle passenger compartment 17 and so that the first inner air blocking face 94 may be utilized to block air flowing into the barrel airflow volume control system 30. Similarly, the lower barrel door 34 may have a second inner air blocking face 96 opposite the second outer air blocking surface 48 so that when the barrel airflow volume control system is in an orientation flipped around the second inner air blocking face 96 may be utilized the block air flowing into the barrel airflow volume control system 30.

The FIG. 3B is a perspective, rear view, with portions sectioned and portions removed of FIG. 3A, and FIG. 3C is an enlarged view of a portion of FIG. 3B. The integrated shaft 64 may have a through hole 61 formed therein and the fork lever 86 may have a rod 89 extending from one end and through the through hole 61 formed in the integrated shaft 64 a rod 89 attached to the fork lever 86 may extend through the through hole 61. A knob 91 may extend from the rod 89 and may be received in a recess 93 of a projection 95 of the airflow direction vane 36 to rotate the airflow direction vane 36. In a number of variations, the knob 91 may have a plurality of sides and the recess 93 may be formed to engage the plurality of sides of the knob 91 to facilitate the rotation of the airflow direction vane 36. In a number of variations, the knob 91 may be cube shaped and have four sides, or triangular shaped having three sides, or variety of other shapes that may have four, five, six or more sides. A pivot rod 100 may be connected to the second end 88 of the second arm 42. The airflow direction vane 36 may have a protrusion 106 received in a through hole 90 formed at one end of the second arm 42. In a number of variations, the upper barrel door 32, lower barrel door 34, and the airflow direction vane 36 may operatively connected together to have the same axis of rotation A.

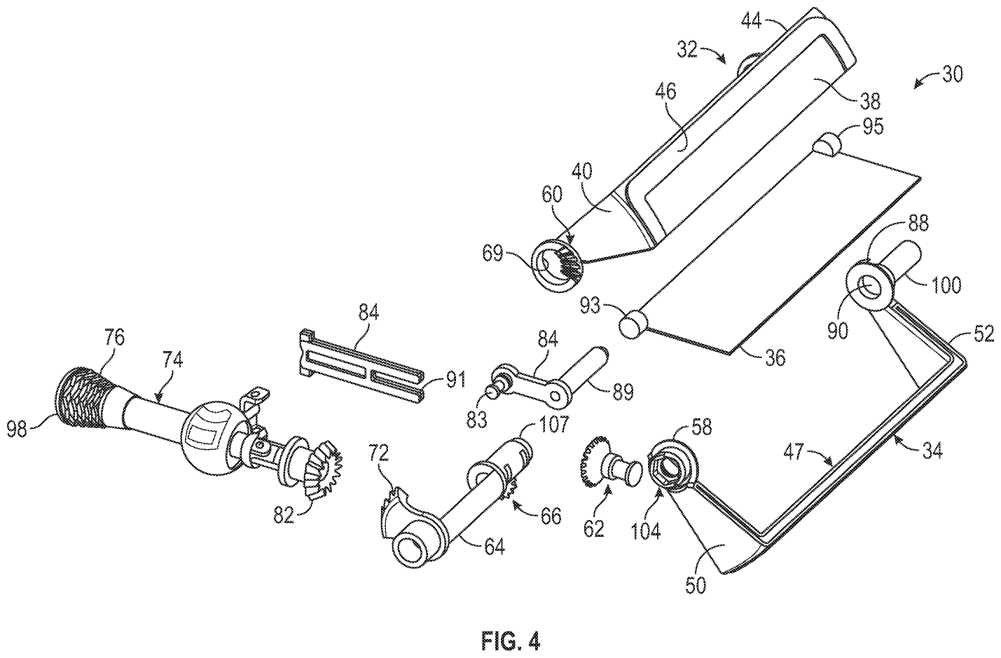

FIG. 4 is an exploded perspective view of a barrel airflow volume control system 30 according to a number of variations. The airflow direction vane 36 may include a projection 95 which may be received in a through hole 90 formed in the second end 88 of the fourth arm 52. A plurality of flats 102 may be formed in the integrated shaft 64 and may engage a plurality of flats 104 formed in the first end 58 of the third arm 50.

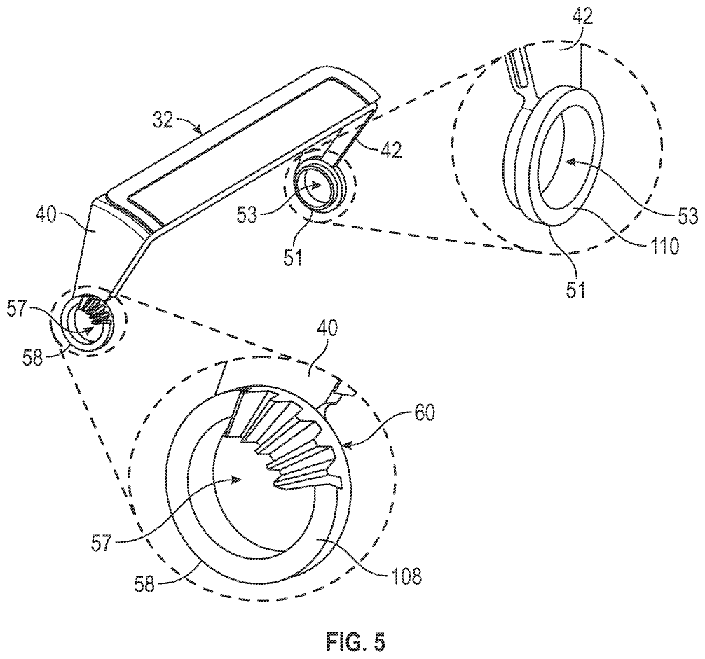

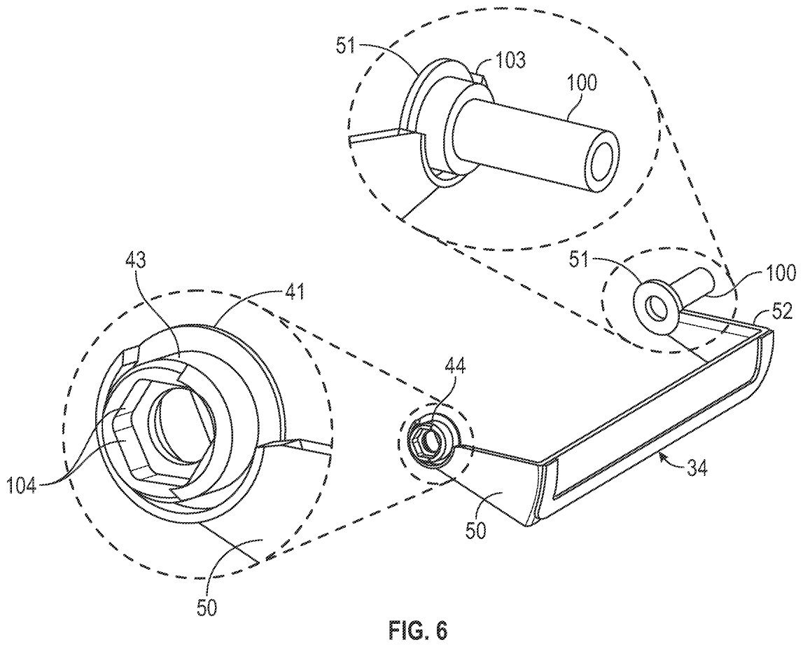

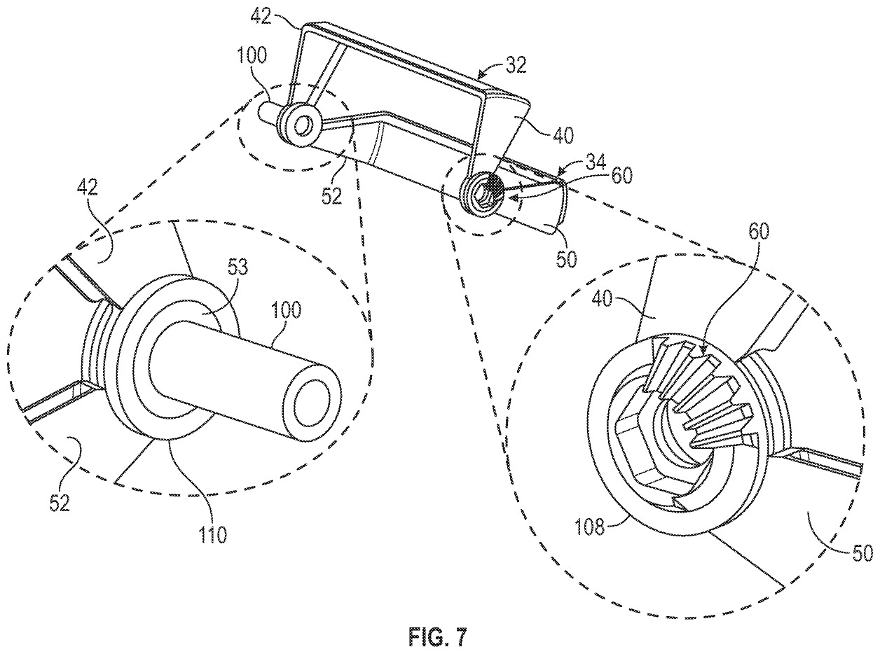

Referring to FIGS. 5-7, the first end 58 of the first arm 40 may have a through hole 57 formed therein and the first end 51 of the second arm 42 may have a through hole 53 formed therein.

The lower barrel door 34 may have a third arm 50 having an end 41 including a first ring portion 43 constructed and arranged to be received in the through hole 57 and the first arm 40. The first end 51 of the fourth arm 52 may include a second ring portion 103 to be received in the through hole 53 formed in the first end 51 of the second arm 42. The upper barrel door 32 and the lower barrel door 34 may be constructed so as to provide concentric rotation about rings, wherein the first ring portion 43 of the fourth arm is received in the through hole 57 formed in first end 58 of the first arm 40 and the second ring portion 103 is received in the through hole 53 of the and 51 of the second arm 42 to provide concentric rotation. The first end 58 includes third ring portion 108 and the first end 51 includes fourth ring portion 110.

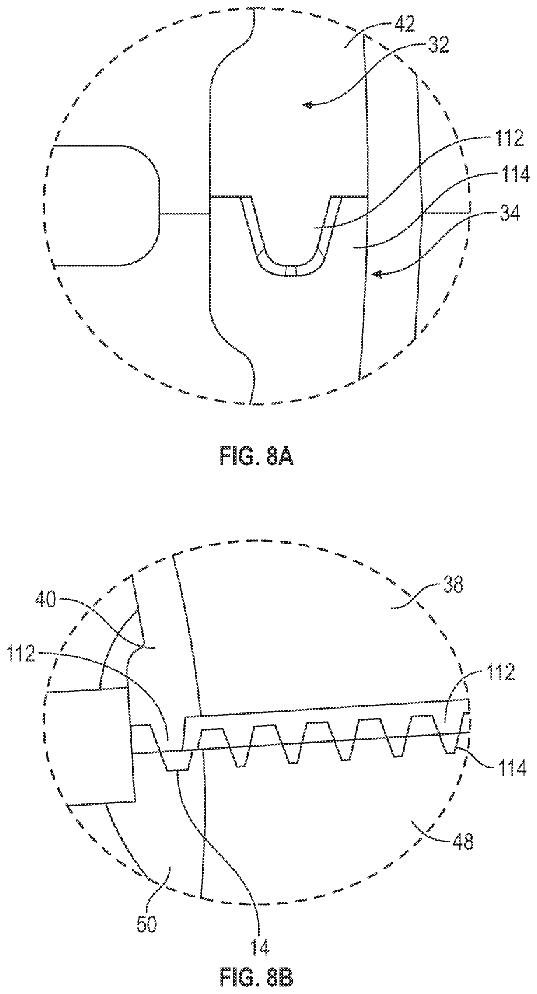

Referring to FIGS. 8A-8B, a plurality of mating tongue 112 and groove 114 features may be provided at the first arm 40 and the third arm 50, at the second arm 42 and the fourth arm 52, and at the first outer air blocking surface 38 and the second outer air blocking surface 48 for sealing purposes and for noise reduction.

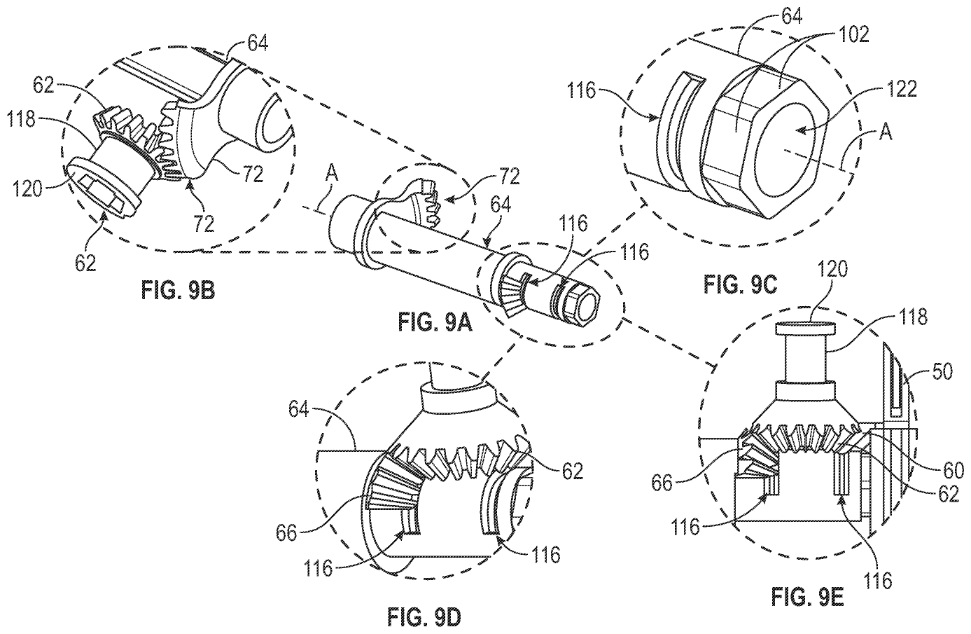

FIG. 9A is a perspective view of the integrated shaft 64 according to a number of variations and may include a plurality of grooves 116 constructed and arranged to receive gear teeth of the second comment gear. FIG. 9B illustrates the engagement of the second conic gear 62 and the fourth conic gear 72 on the integrated shaft 64. The second conic gear 62 may include a rod portion 118 and a cap or head 120 extending radially outward from the rod portion 118. The rod portion 118 may be received in a slot formed in a housing (not shown) to facilitate rotational movement of the second conic gear 62. FIG. 9C illustrates a portion of the integrated shaft 64 which may include a through hole 122. FIG. 9D illustrates the engagement of the second conic gear 62 with the third conic gear 66 on the integrated shaft 64 wherein a pair of grooves 116 formed in the integrated shaft 64 receive some of the gear teeth of the second conic gear 62 to facilitate rotation of the second conic gear 62. The grooves 116 may be parallel to each other. FIG. 9E illustrates the engagement of the second conic gear 62 with the third conic gear 66 and the first conic gear 60 wherein some of the gear teeth of the second conic gear 62 may be received in the pair of grooves 116.

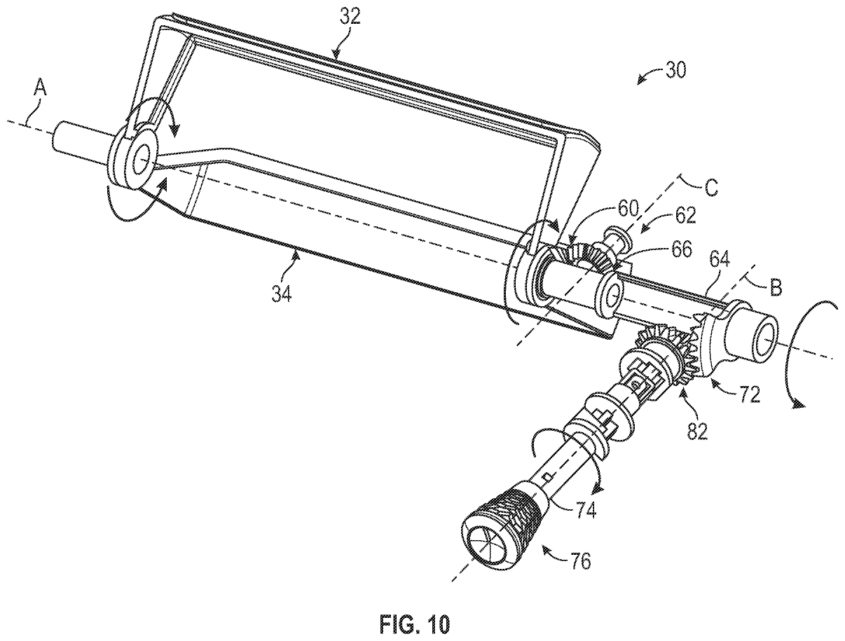

FIG. 10 is a perspective, front view of a barrel airflow volume control system 30 illustrating a first axis A of rotation of the upper barrel door 32 and lower barrel door 34, and second axis B of rotation be of the joystick 74, and third axis C of rotation of their integrated shaft 64, wherein the first axis A of rotation is perpendicular to both the second axis B of rotation and the third axis C of rotation, and wherein the second axis B of rotation and the third axis C of rotation are parallel to each other. The third conic gear 66 of the integrated shaft 64 is best seen in FIG. 2.

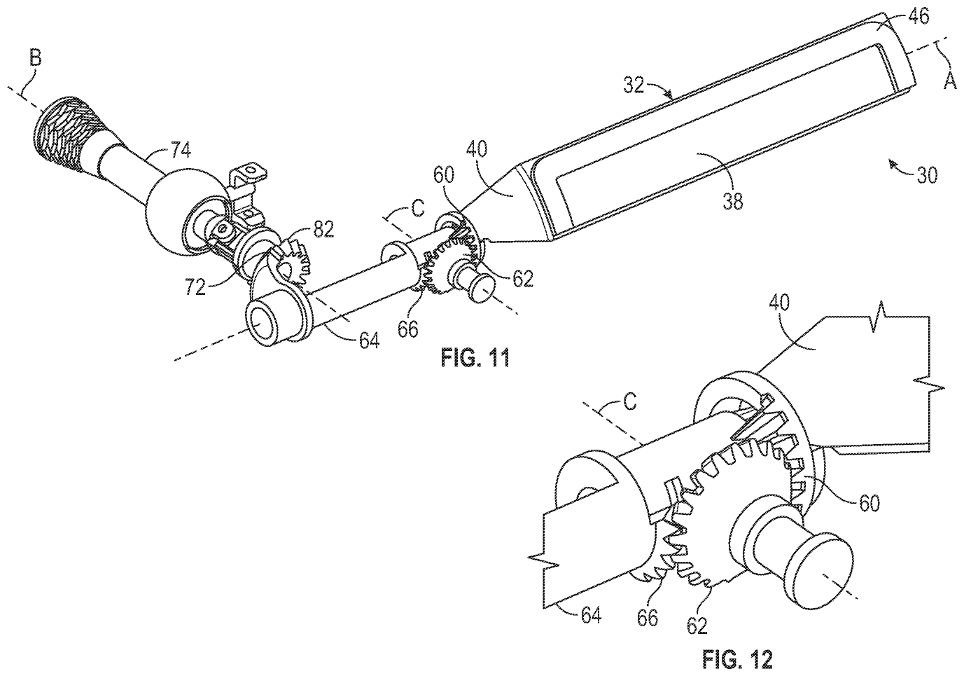

FIG. 11 is a perspective, rear view of a portion of an airflow volume control system barrel illustrating the upper door actuation using components and illustrating three axes of rotation. FIG. 12 is a partial, enlarged view of a portion of FIG. 11.

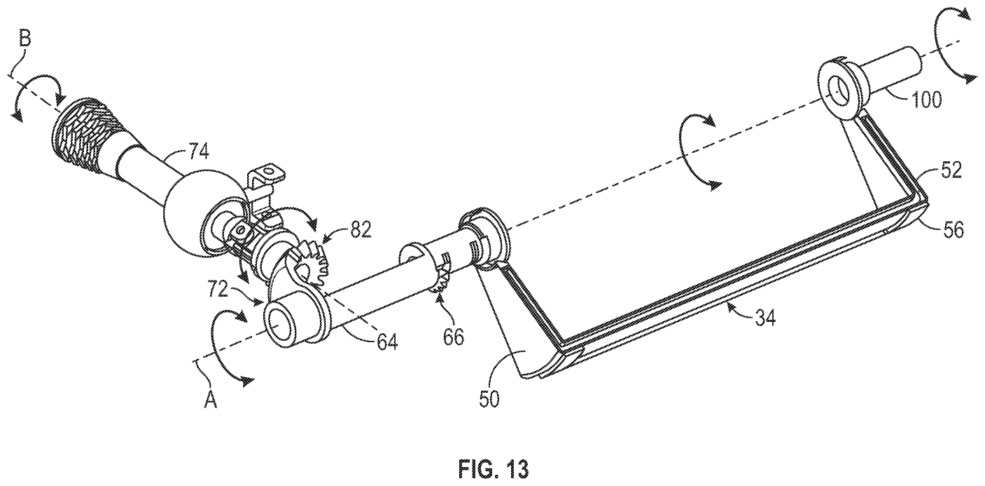

FIG. 13 is a perspective, rear view of a portion of a barrel airflow volume control system 30 illustrating the lower door actuation using components and illustrating two axes of rotation.

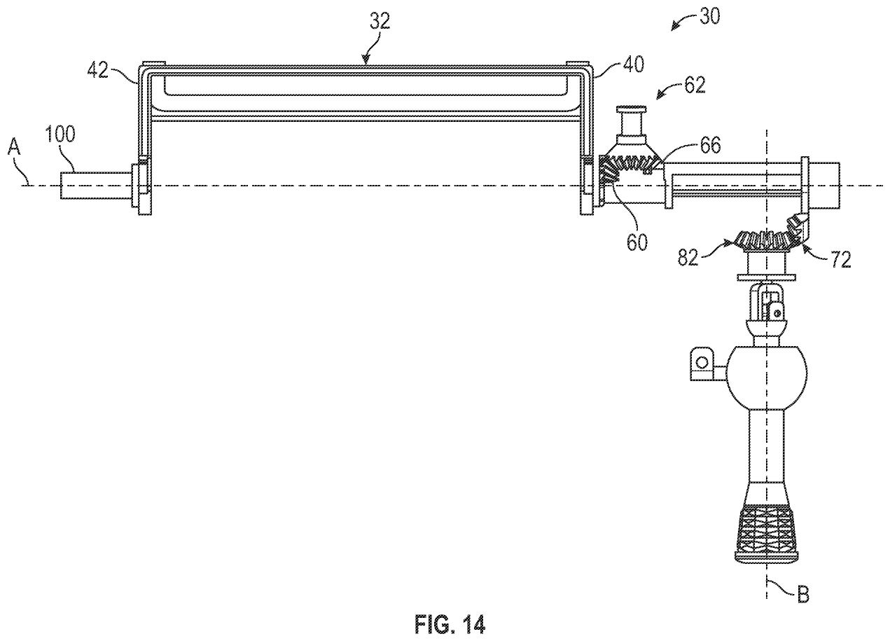

FIG. 14 illustrate the axis A of rotation of the upper barrel door 32 with respect to the axis B of rotation of the joystick 74.

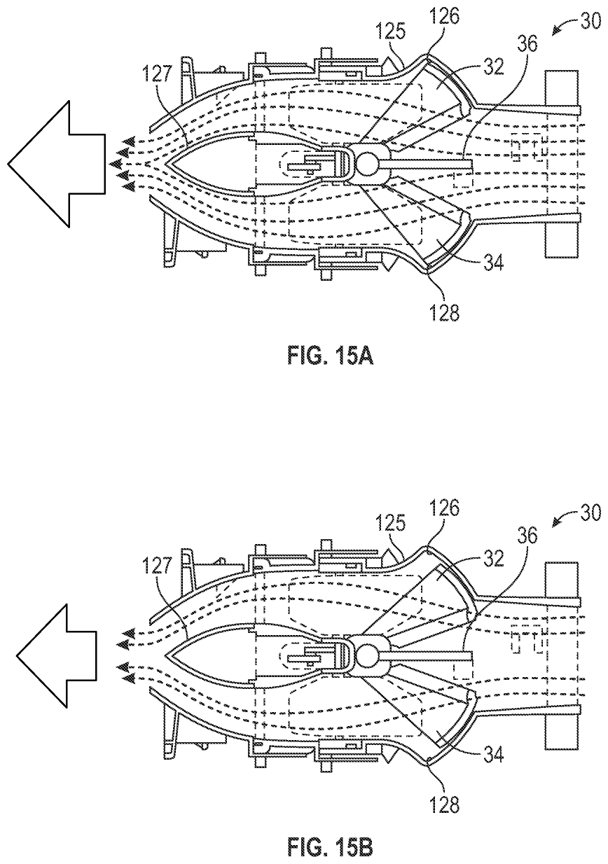

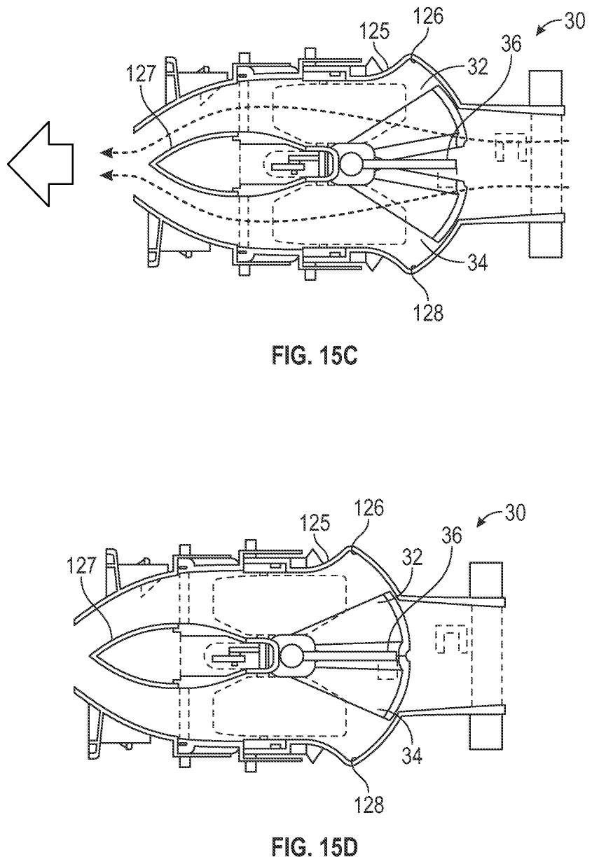

FIG. 15A is a schematic illustration of a barrel airflow volume control system 30 wherein the barrel doors 32 and 34 are in a fully open position and there is maximum airflow volume through the barrel airflow volume control system 30.

FIG. 15B is a schematic illustration of a barrel airflow volume control system 30 wherein the barrel doors 32 and 34 are in a 75% open position and there is reduced airflow volume through the barrel airflow volume control system 30.

FIG. 15C is a schematic illustration of a barrel airflow volume control system 30 wherein the barrel doors 32 and 34 are in a 25% open position and there is reduced airflow volume through the barrel airflow volume control system 30.

FIG. 15D is a schematic illustration of a barrel airflow volume control system 30 wherein the barrel doors 32 and 34 are in a fully closed position and there is reduced airflow volume through the barrel airflow volume control system 30.

Referring to FIGS. 15A-15D and FIGS. 16-20, a housing 125 may have a first surface 126 on which the upper barrel door 32 or first sealing material 46 seals on, and a second surface 128 on which the lower barrel door 34 or sealing material 56 seals on. An island 127 may be provide and may have two sidewalls that converge on each other and which, along with surface on the housing, directs air flow.

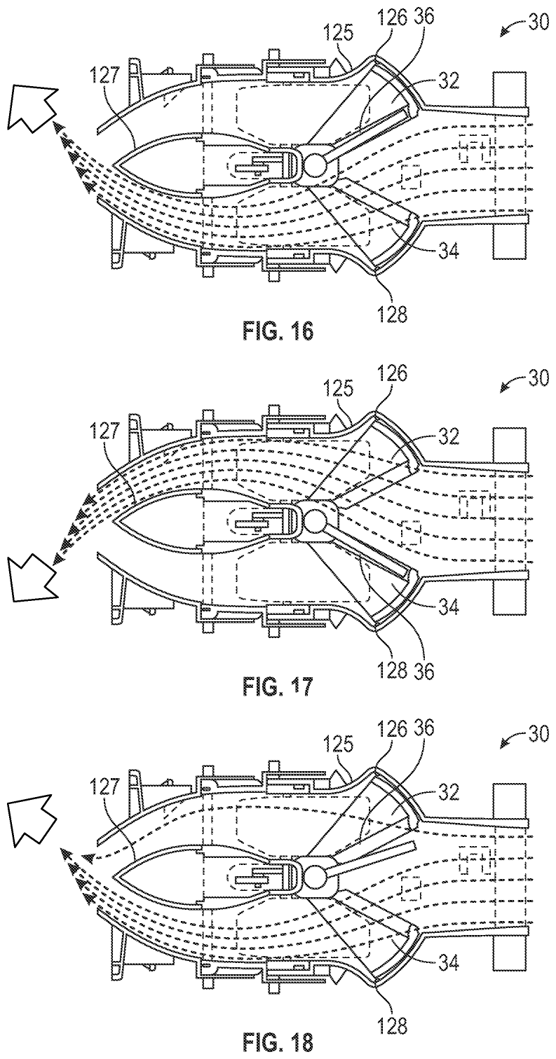

FIG. 16 is a schematic illustration of a barrel airflow volume control system 30 with the airflow direction vane 36 completely blocking an opening in the upper barrel door 32 and wherein the lower barrel door 34 is completely open so that the air exiting the barrel airflow volume control system 30 is in an upward direction towards a vehicle occupant's face;

FIG. 17 is a schematic illustration of a barrel airflow volume control system 30 with the airflow direction vane 36 completely blocking an opening in the lower barrel door 34 and wherein the upper barrel door 32 is completely open so that the air exiting the barrel airflow volume control system 30 is in a downward direction towards a vehicle occupant's feet.

FIG. 18 is a schematic illustration of a barrel airflow volume control system 30 with the airflow direction vane 36 is partially blocking an opening in the upper barrel door 32 but with relatively small volume of air flowing through the upper barrel door 32 and wherein the lower barrel door 34 is completely open so that the air exiting the barrel airflow volume control system 30 is in an upward direction towards a vehicle occupant's face.

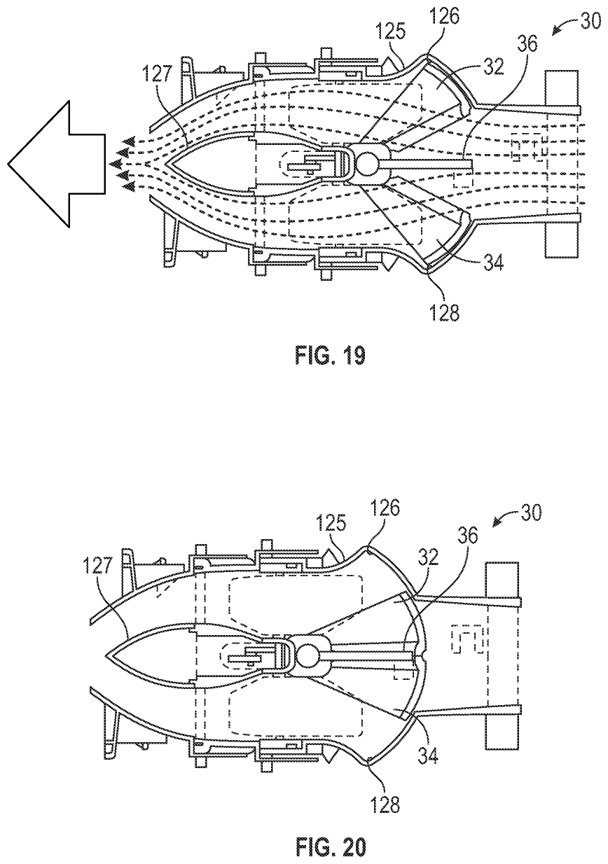

FIG. 19 is a schematic illustration of a barrel airflow volume control system 30 with the airflow direction vane 36 is centered with respect to the upper barrel door 32 and the lower barrel door 34, and the upper barrel door 32 and the lower barrel door 34 are both completely open so that the air exiting the barrel airflow volume control system 30 is in a direction between a vehicle occupant's face and feet.

FIG. 20 is a schematic illustration of a barrel airflow volume control system 30 with the airflow direction vane 36 is centered with respect to the upper barrel door 32 and the lower barrel door 34 so that the upper barrel door 32 and the lower barrel door 34 are completely closed and no air is flowing through the barrel airflow volume control system 30.

While at least one illustrative variation has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A product comprising:
a barrel airflow volume control system, for a vehicle, comprising a first barrel door and a second barrel door operatively connected together so that the first barrel door and the second barrel door move away from each other to provide an air passageway opening therebetween, and move toward each other to reduce or close the air passageway opening between the first barrel door and the second barrel door.

2. The product as set forth in claim 1, wherein the upper barrel door includes a first barrel portion having a first outer air blocking surface and a first arm and a second arm extending from opposite ends of the first barrel portion to define a first airflow opening between the first arm, second arm, and the first barrel portion, and wherein the lower barrel door includes a second barrel portion having a second outer air blocking surface, and a third arm, and fourth arm extending from opposite ends of the second barrel portion to define a second airflow opening between the third arm, fourth arm, and second barrel portion.

3. The product as set forth in claim 2 wherein a first outer air blocking surface is curved or has a convex shape.

4. The product as set forth in claim 1 wherein the upper barrel door includes a first barrel portion having a first inner air blocking surface and a first arm and a second arm extending from opposite ends of the first barrel portion to define a first airflow opening between the first arm, second arm, and the first barrel portion, and wherein the lower barrel door includes a second barrel portion having a second inner air blocking surface, and a third arm, and fourth arm extending from opposite ends of the second barrel portion to define a second airflow opening between the third arm, fourth arm, and second barrel portion.

5. The product as set forth in claim 2 further comprising a first sealing material over a portion of the first outer air blocking surface, and a second sealing material over a portion of the second outer air blocking surface.

6. The product as set forth in claim 1 wherein the first arm includes a first conic gear at one end of the first arm, and further comprising a second conic gear and operative connection with the first conic gear, wherein the second conic gear is held for rotational movement by a housing.

7. The product as set forth in claim 6 further comprising an integrated shaft having a third conic gear operatively connected to the second conic gear.

8. The product as set forth in claim 7 wherein the integrated shaft has a first end extending through a through hole formed in the first arm.

9. The product as set forth in claim 8 wherein the integrated shaft includes a second end having fourth conic gear near the second end of the integrated shaft.

10. The product as set forth in claim 9 further comprising a joystick having a rotary knob near a first end and a second end of the joystick including ⅕ conic gear position to engage the fourth conic gear.

11. The product as set forth in claim 10 further comprising a fork operatively connected to the joystick and a fork lever operatively connected to the fork.

12. The product as set forth in claim 11 further comprising an airflow direction vane positioned between the upper barrel door and the second barrel door and connected to the fork lever to facilitate rotational movement of the airflow direction vane.

13. The product as set forth in claim 12 wherein the airflow direct vane may be moved to a position centered between the upper barrel door and lower barrel door, to a position partially or completely blocking the opening in the upper barrel door, to a position partially or completely blocking the opening in the lower barrel door.

14. The product is set forth in claim 12 wherein the integrated shaft has a cavity for receiving a portion of the fork lever and where a portion of the fork lever extends through a through hole in the integrated shaft.

15. The product as set forth in claim 14 wherein the fork lever includes a rod extending through a through hole in the integrated shaft, and a knob extending from the rod and received in a recess in the airflow direction vane to facilitate rotational movement of the airflow direction vane.

16. The product as set forth in claim 15 wherein the airflow direction vane includes a projection received in a through hole formed in the second end of the fourth arm.

17. The product as set forth in claim 16 wherein the integrated shaft includes a plurality of flats operatively engaging a plurality of flats formed in a first end of the third arm.

18. The product is set forth in claim 1 wherein the third arm has an end including a first ring portion constructed and arranged to be received in a through hole in the first arm.

19. A system comprising:
a barrel airflow volume control system, for a vehicle, comprising a first barrel door and a second barrel door operatively connected together so that the first barrel door and the second barrel door move away from each other to provide an air passageway opening therebetween, and move toward each other to reduce or close the air passageway opening between the first barrel door and the second barrel door;
wherein the upper barrel door includes a first barrel portion having a first outer air blocking surface, and a first arm and a second arm extending from opposite ends of the first barrel portion to define a first airflow opening between the first arm, second arm, and the first barrel portion, and wherein the lower barrel door includes a second barrel portion having a second outer air blocking surface, and a third arm, and fourth arm extending from opposite ends of the second barrel portion to define a second airflow opening between the third arm, fourth arm, and second barrel portion;
an airflow direction vane positioned between the upper barrel door and the lower barrel door and connected to the fork lever to facilitate rotational movement of the airflow direction vane from a first position centered with respect to the upper barrel door and the lower barrel door to the second position partially or completely closing an airflow opening in the upper barrel door to third position partially or completely closing an airflow opening in the lower barrel door.

20. A method comprising:
providing a barrel airflow volume control system, for a vehicle, comprising a first barrel door and a second barrel door operatively connected together so that the first barrel door and the second barrel door, wherein the upper barrel door includes a first barrel portion having a first outer air blocking surface and a first arm and a second arm extending from opposite ends of the first barrel portion to define a first airflow opening between the first arm, second arm, and the first barrel portion, and wherein the lower barrel door includes a second barrel portion having a second outer air blocking surface, and a third arm, and fourth arm extending from opposite ends of the second barrel portion to define a second airflow opening between the third arm, fourth arm, and second barrel portion, and an airflow direction vane positioned between the upper barrel door and the second barrel door and connected to the fork lever to facilitate rotational;
moving the airflow direction vane from a first position centered with respect to the upper barrel door and the lower barrel door to the second position partially or completely closing an airflow opening in the upper barrel door to third position partially or completely closing an airflow opening in the lower barrel door;
moving the upper barrel door and lower barrel door away from each other to provide an air passageway opening therebetween, and toward each other to reduce or close the air passageway opening between the first barrel door and the second barrel door.
